(19) United States
(12) Patent Application Publication
(10) Pub. No.: US 2026/0200008 A1
(43) Pub. Date: Jul. 16, 2026

(54) INTEGRATED ADDITIVE, SUBTRACTIVE AND REPAIR FRICTION STIR DEVICE AND METHOD

(71) Applicant: Harbin Institute of Technology, Harbin (CN)

(72) Inventors: Yongxian HUANG, Harbin (CN); Yuming XIE, Harbin (CN); Xiangchen MENG, Harbin (CN); Wenjiang DONG, Harbin (CN); Xiaotian MA, Harbin (CN); Naijie WANG, Harbin (CN)

(73) Assignee: Harbin Institute of Technology, Harbin (CN)

(21) Appl. No.: 19/444,261

(22) Filed: Jan. 9, 2026

(30) Foreign Application Priority Data
Jan. 16, 2025 (CN) 202510066132.2

(51) Int. Cl. B23K 20/12; B23K 20/26; B23K 31/12; B33Y 10/00; B33Y 30/00; B33Y 40/20

(52) U.S. Cl. CPC B23K 20/1245; B23K 20/1215; B23K 20/26; B23K 31/125; B33Y 10/00; B33Y 30/00; B33Y 40/20

(57) ABSTRACT

An integrated additive, subtractive and repair friction stir device and method. To overcome the limitations of conventional subtractive manufacturing in handling a complex geometry, the device includes a friction stir additive manufacturing (FSAM) module, a subtractive module, a wire feeding module, and a surface profile detection module, where the FSAM module is fixedly connected to a first rotor of a spindle; the subtractive module is located in the FSAM module and fixedly connected to a second rotor of the spindle; the wire feeding module is configured to supply a wire material to the FSAM module and the subtractive module, respectively; and the surface profile detection module is configured to perform real-time detection of a surface quality of a deposited layer. The device, by combining a laser profile sensing technology, an additive technology, and a substractive technology, enables real-time detection of the forming conditions to ensure the forming quality.

### RELATED APPLICATIONS

This application claims the benefit of priority of Chinese application number 2025100661322, filed on January 16, 2025. The entire contents of the above-mentioned applications are incorporated herein by reference.

### TECHNICAL FIELD

The present disclosure relates to a friction stir device and method, and in particular to an integrated additive, subtractive and repair friction stir device and method, and belongs to the technical field of friction stir additive manufacturing (FSAM).

### BACKGROUND

As a solid-phase additive manufacturing method, FSAM enables deposition of a wire or rod material in a thermoplasticized state through a processing principle of material friction extrusion and plastic deformation. A temperature in a deposition process is far below a solidus temperature of the deposited material, and the intrinsic attribute of transitioning directly from "a solid phase" to "a solid phase" directly eliminates problems common in a case that a metal is melted for additive manufacturing, such as element loss, structural inhomogeneity, porosity, and hot cracking. During solid-phase additive manufacturing, the deposited material undergoes severe plastic deformation, and retains the dynamic recrystallization feature, thereby resulting in a uniform and fine grain structure in a deposited layer. Therefore, an additively manufactured component usually exhibits a dense structure and excellent properties, and the solid-phase additive manufacturing has a significant application potential in manufacturing of lightweight alloy components.

Chinese Publication No. CN117600641A discloses a powder-bed and wire-feeding combined type FSAM device. However, in an additive process, an additively manufactured component is manufactured via two-dimensional stacking from the bottom up, leading to high surface roughness and low machining accuracy, with the surface accuracy of the component being far inferior to the surface accuracy of conventional additive processing. A component with a complex structure usually requires secondary processing. Moreover, in practical production, defects easily occur in the additively manufactured component due to equipment accuracy errors or inappropriate parameter selection. Limitations exist in eliminating these defects and improving the processing accuracy of the additively manufactured component.

Chinese Publication No. CN113618330A discloses a visual sensing system for defect identification. However, the visual sensing technology has relatively low accuracy, exhibits a short measurement range, and is susceptible to ambient light. Real-time defect detection in the additive process requires high accuracy and resolution.

Therefore, there is an urgent need for a friction stir device and method that integrate solid-phase additive, subtractive, and repair remanufacturing to solve the above problems.

### SUMMARY

To solve the above technical problems in the prior art, the present disclosure provides an integrated additive, subtractive and repair friction stir device and method.

The technical solution employed by the present disclosure to solve the above problems is as follows:

An integrated additive, subtractive and repair friction stir device includes an FSAM module, a subtractive module, a wire feeding module, and a surface profile detection module, where the FSAM module is fixedly connected to a first rotor of a spindle; the subtractive module is located in the FSAM module and fixedly connected to a second rotor of the spindle; the wire feeding module is configured to supply a wire material to the FSAM module and the subtractive module, respectively; and the surface profile detection module is detachably connected to the FSAM module and is configured to perform real-time detection of a surface quality of a deposited layer.

Further, the FSAM module includes a stirring tool and a compression ring, where a lower end of the stirring tool is inserted into the compression ring, the stirring tool includes a first clamping end, a cutting portion, and stirring pins, and the first clamping end, the cutting portion, and the stirring pins are connected sequentially from top to bottom into an integral structure; an upper end of the compression ring is provided with a second clamping end, the second clamping end is fixedly connected to a stator of the spindle via fastening screws, and a lower end of the compression ring is provided with a shoulder; and the shoulder is located on a lower end face of the compression ring, configured as a planar or concave surface, and configured to constrain the material. A first wire feeding hole is formed in a side wall of the compression ring.

Further, the subtractive module includes a milling cutter, where an upper end of the milling cutter is fixedly connected to the second rotor of the spindle, and a second wire feeding hole is formed in a side surface of the milling cutter. The second wire feeding hole is maintained coaxial with the first wire feeding hole.

Further, the wire feeding module includes a wire feeder and the wire material, where the wire material is supplied to the FSAM module and the subtractive module through the wire feeder.

Further, the surface profile detection module includes a data processing unit, a laser profile sensor, and a connecting plate, where the data processing unit and the laser profile sensor are mounted on a lower surface of the connecting plate from top to bottom, the laser profile sensor is provided with a laser emitter and a receiver, the laser emitter is configured to project a laser beam onto a surface of a detected object, and the receiver is configured to receive a reflected light signal, and transmit the signal to the data processing unit.

An integrated additive, subtractive and repair friction stir method is implemented through the following steps:

step 1, performing additive manufacturing through an FSAM module;

step 2, detecting a surface defect of an additive layer through a surface profile detection module, and repairing the defect through a subtractive module; and restarting the additive process after repair is completed; and

step 3, after an additively manufactured component is manufactured, performing precision machining on the additively manufactured component through the subtractive module.

Further, the step 1 specifically includes: when the additive process starts, a first rotor of a spindle starts operating and rotates at a high speed, while a second rotor remains stationary; a wire material is continuously and uninterruptedly passed sequentially through a first wire feeding hole and a second wire feeding hole; subsequently, the wire material contacts a high-speed rotating cutting portion and is sheared into small particles, and due to a high-speed relative motion between a high-speed rotating stirring tool and the non-rotating subtractive module, the sheared wire material flows along a processing path of a helical groove of the cutting portion; and when flowing to a bottom, the thermoplasticized material is deposited under the action of stirring pins and a compression ring to form a dense additive layer.

Further, the step 2 specifically includes: when the spindle starts additive deposition along a preset path, the surface profile detection module located behind the spindle, i.e., above the deposited layer, starts operating; and a laser emitter projects a laser beam onto a surface of a detected object, a receiver receives a reflected laser signal and transmits the signal to a data processing unit. A defect analysis is performed on an acquired image to obtain a defect location, a defect depth, and a defect type of the deposited layer; subsequently, a wire feeder stops wire feeding and controls retraction of the wire material, and the spindle of the device starts to lift and moves to a starting position of the defect; and at this moment, the first rotor of the spindle stops rotating, the second rotor of the spindle starts operating and rotates at a high speed, and independently controls the subtractive module to start moving axially downward, the surface defect of the deposited layer is removed by milling with a milling cutter, and after the surface defect is removed and the second rotor controls the subtractive module to move axially to an initial preset position, the additive process restarts.

Further, the step 3 specifically includes: after the additively manufactured component is manufactured, the wire feeder stops wire feeding; the first rotor of the spindle stops rotating, the second rotor starts operating and rotates at high speed, and independently controls the subtractive module to start moving axially downward; and when a length of helical teeth extending at a lower end of the subtractive module below an end plane of the cutting portion meets the requirement, axial movement stops, and finally, the spindle controls the subtractive module to perform precision machining on the additively manufactured component according to a preset subtractive machining path.

The present disclosure has the following beneficial effects:

1. In the present disclosure, a laser profile sensing technology is applied to acquire high-precision defect depth information and a surface shape in real time in the additive process, and a subtractive technology is used as an auxiliary process for repair remanufacturing to achieve quasi-equal-strength repair of the defect, so as to effectively overcome the limitations of conventional subtractive manufacturing in handling a complex geometry, and leverage the advantages of additive manufacturing in terms of material utilization efficiency and design freedom.

2. In the present disclosure, the surface profile detection module is used to perform real-time detection of the surface quality of the deposited layer, and the detection results are highly accurate; and the defect is promptly eliminated according to the detection results, thereby ensuring the forming quality of the additively manufactured component and saving production costs.

3. The present disclosure combines the additive process and subtractive process to enable continuous deposition-milling machining of a complex component on the same equipment, thereby providing higher equipment flexibility, improving the machining accuracy of the additively manufactured component, reducing the time and cost required for a conventional post-processing procedure, and effectively enhancing manufacturing efficiency.

4. The present disclosure provides a friction stir device integrating additive, subtractive, and repair remanufacturing, with a plurality of structural functions and strong flexibility, which significantly simplifies the complexity and large size of conventional additive and subtractive systems. The device is suitable for field long-distance transportation and on-site manufacturing and remanufacturing.

5. The present disclosure has a wide range of application and may be used for integrated forming and manufacturing of aluminum and aluminum alloys, magnesium alloys, copper alloys, titanium alloys, and composite materials.

### BRIEF DESCRIPTION OF THE DRAWINGS

FIG. 1 is an overall schematic structural view of a friction stir device that integrates solid-phase additive, subtractive, and repair remanufacturing according to the present disclosure.

FIG. 2 is a sectional view of a friction stir device that integrates solid-phase additive, subtractive, and repair remanufacturing according to the present disclosure.

FIG. 3 is a schematic diagram of a subtractive module removing defects in an additive layer according to the present disclosure.

### DETAILED DESCRIPTIONS OF THE EMBODIMENTS

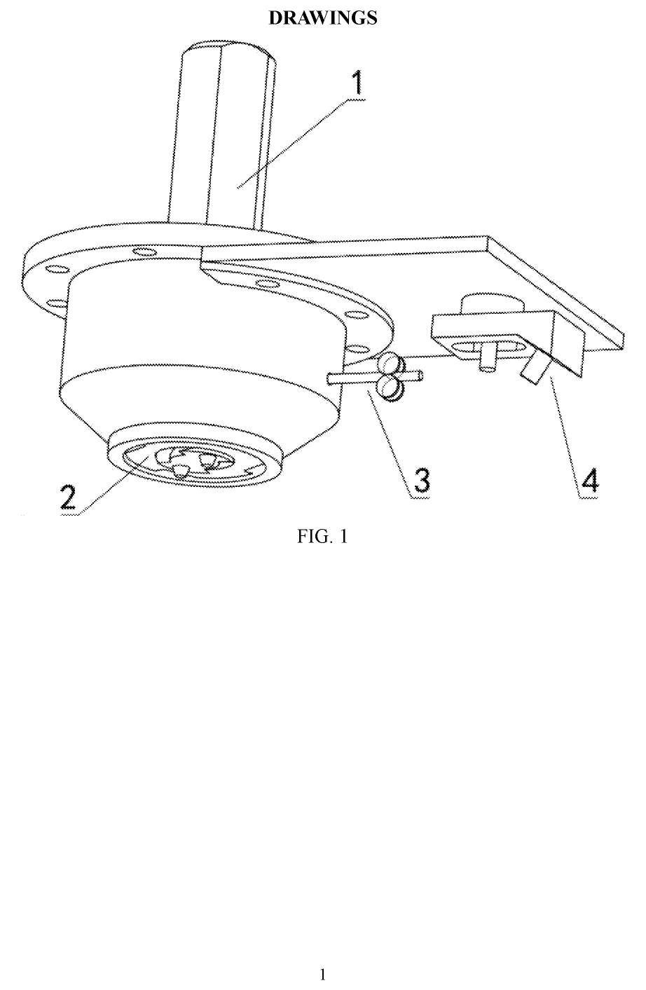

As shown in FIG. 1, an integrated additive, subtractive and repair friction stir device in this embodiment includes an FSAM module 1, a subtractive module 2, a wire feeding module 3, and a surface profile detection module 4, where the FSAM module 1 is fixedly connected to a first rotor of a spindle; the subtractive module 2 is located in the FSAM module 1 and fixedly connected to a second rotor of the spindle; the wire feeding module 3 is configured to supply a wire material to the FSAM module 1 and the subtractive module 2, respectively; and the surface profile detection module 4 is detachably connected to the FSAM module 1 and is configured to perform real-time detection of a surface quality of a deposited layer. The first rotor and the second rotor of the spindle are independent of each other and capable of relative axial movement.

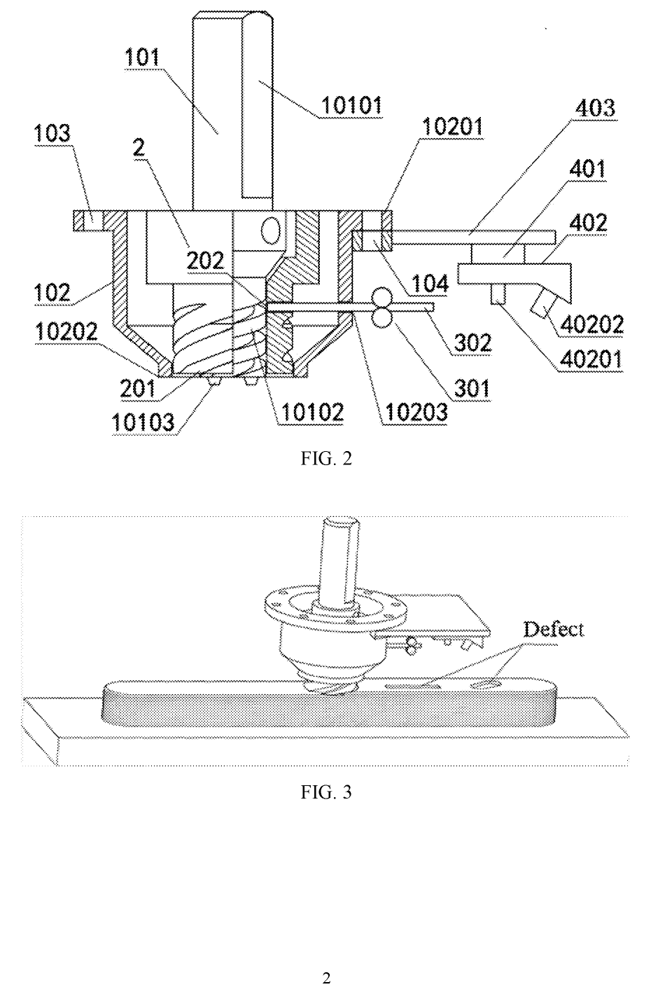

As shown in FIG. 2, the FSAM module 1 includes a stirring tool 101 and a compression ring 102, where a lower end of the stirring tool 101 is inserted into the compression ring 102, the stirring tool 101 includes a first clamping end 10101, a cutting portion 10102, and stirring pins 10103, and the first clamping end 10101, the cutting portion 10102, and the stirring pins 10103 are connected sequentially from top to bottom into an integral structure; an upper end of the compression ring 102 is provided with a second clamping end 10201, the second clamping end 10201 is fixedly connected to a stator of the spindle via fastening screws 103, and a lower end of the compression ring 102 is provided with a shoulder 10202; and the shoulder 10202 is located on a lower end face of the compression ring 102, configured as a planar or concave surface, and configured to constrain the material. A first wire feeding hole 10203 is formed in a side wall of the compression ring 102.

Due to a relative motion formed between the stirring tool 101 and an inner wall of the subtractive module 2, small sheared particles flow downward along a processing path of a helical groove under the action of an own gravity as well as a friction with an inner wall of the subtractive module 2 and an inner wall of the helical groove of the cutting portion 10102.

Preferably, a helical groove spacing of the cutting portion 10102 is 2-3 times a diameter of the wire. The number of screw flights is two or three, and a cutting speed increases with the number of flights.

Preferably, the stirring pins 10103 are located at a bottom end face of the stirring tool, and symmetrically distributed, and the number thereof is 2-3.

Preferably, a hardness and a melting point of each stirring pin 10103 are higher than a hardness and a melting point of the deposited material. A material of each stirring pin 10103 includes, but is not limited to, hard alloy steel, tool steel, and mold steel.

As shown in FIG. 2, the subtractive module 2 includes a milling cutter 201, where an upper end of the milling cutter 201 is fixedly connected to the second rotor of the spindle, and a second wire feeding hole 202 is formed in a side surface of the milling cutter 201. The second wire feeding hole 202 is maintained coaxial with the first wire feeding hole 10203.

Preferably, a clearance between the inner wall of the subtractive module 2 and the stirring tool 101 is 0.1-0.2 mm, and is used for constraining material flow. A clearance between an inner wall of the compression ring 102 and an outer wall of the subtractive module 2 is 0.1-0.2 mm. The subtractive module 2 and the compression ring 102 coact to constrain the material flow.

Preferably, teeth of the milling cutter 201 are distributed circumferentially, and configured to mill an additively manufactured component to improve the surface accuracy of the component. A plane at a lower end portion of the milling cutter 201 is 0.5-1 mm higher than a plane at an end 10202 of the compression ring.

Preferably, a hardness and a melting point of each tooth are higher than a hardness and a melting point of the wire material to be fed.

As shown in FIG. 2, the wire feeding module 3 includes a wire feeder 301 and the wire material 302, where the wire material 302 is supplied to the FSAM module 1 and the subtractive module 2 through the wire feeder 301.

Preferably, the wire feeder 301 is configured to precisely control a wire feeding speed, with a stable feeding process and a wire retraction function. The wire material 302 includes, but is not limited to, an aluminum alloy, a magnesium alloy, a copper alloy, a titanium alloy, and a composite material.

As shown in FIG. 2, the surface profile detection module 4 includes a data processing unit 401, a laser profile sensor 402, and a connecting plate 403, where connecting plate 403 and the compression ring 102 are connected by fastening screws, the data processing unit 401 and the laser profile sensor 402 are mounted on a lower surface of the connecting plate 403 from top to bottom, the laser profile sensor 402 is provided with a laser emitter 40201 and a receiver 40202, the laser emitter 40201 is configured to project a laser beam onto a surface of a detected object, and the receiver 40202 is configured to receive a reflected light signal, and transmit the signal to the data processing unit 401. Based on the received reflected signal, height variation or profile data of an object surface are obtained by calculating a time difference, displacement, or angle change of the reflected beam. A three-dimensional surface profile is finally formed by acquiring a large number of height points through scanning, and precise measurement of a defect shape and depth is achieved.

Specific Embodiment II: This embodiment provides an integrated additive, subtractive and repair friction stir method, where the method is implemented through the following steps:

Step 1, when an additive process starts, a first rotor of a spindle starts operating and rotates at a high speed, while a second rotor remains stationary; a wire material 302 is continuously and uninterruptedly passed sequentially through a first wire feeding hole 10203 and a second wire feeding hole 202; subsequently, the wire material 302 contacts a high-speed rotating cutting portion 10102 and is sheared into small particles, and due to a high-speed relative motion between a high-speed rotating stirring tool 101 and the non-rotating subtractive module 2, the sheared wire material 302 flows along a processing path of a helical groove of the cutting portion; and when flowing to a bottom, the thermoplasticized material is deposited under the action of stirring pins 10103 and a compression ring 102 to form a dense additive layer.

Step 2, when the spindle starts additive deposition along a preset path, the surface profile detection module 4 located behind the spindle, i.e., above the deposited layer, starts operating; and a laser emitter 40201 projects a laser beam onto a surface of a detected object, and a receiver 40202 receives a reflected laser signal and transmits the signal to a data processing unit 401. A corresponding detection algorithm is employed and a defect analysis is performed on an acquired image to obtain a defect location, a defect depth, and a defect type of the deposited layer; subsequently, a wire feeder 301 stops wire feeding and controls retraction of the wire material 302, and the spindle of the device starts to lift and moves to a starting position of a defect; at this moment, the first rotor of the spindle stops rotating, and the second rotor of the spindle starts operating and rotates at a high speed, and independently controls the subtractive module 2 to start moving axially downward; and when an end plane of a milling cutter of the subtractive module is 5-8 mm below a shoulder plane of the compression ring, axial movement is stopped, the milling cutter 201 is controlled by the spindle to remove the surface defect of the deposited layer by milling, and after the surface defect is removed and the second rotor controls the subtractive module 2 to move axially to an initial preset position, the additive process restarts.

Step 3, after an additively manufactured component is manufactured, the wire feeder 301 stops wire feeding; the first rotor of the spindle stops rotating, the second rotor starts operating and rotates at a high speed, and independently controls the subtractive module 2 to start moving axially downward; and when a length of helical teeth extending at a lower end of the subtractive module 2 below an end plane of the cutting portion 10102 meets the requirement, axial movement stops, and finally, the spindle controls the subtractive module 2 to perform precision machining on the additively manufactured component according to a preset subtractive machining path.

In the present disclosure, a laser profile sensing technology is applied to acquire high-precision defect depth information and a surface shape in real time in the additive process, and a subtractive technology is employed as an auxiliary process for repair remanufacturing to achieve quasi-equal-strength repair of the defect, so as to effectively overcome the limitations of conventional subtractive manufacturing in handling a complex geometry, and leverage the advantages of additive manufacturing in terms of material utilization efficiency and design freedom. Through this technical synergy, the present disclosure may not only significantly enhance production efficiency and reduce overall costs, but also achieve higher processing accuracy and more flexible design customization, making it particularly suitable for manufacturing of high-performance and complex structures.

The above descriptions are only preferred embodiments of the present disclosure, and should not be construed as a limitation to the present disclosure in any form. Although the present disclosure has been disclosed through the preferred embodiments, such disclosure is not intended to limit the present disclosure. Any person skilled in the art may, without departing from the technical solutions of the present disclosure, make numerous alterations or modifications to the disclosed technical contents to obtain equivalent embodiments of equivalent variations. Any simple modifications, equivalent substitutions, or improvements, made to the above embodiments according to the technical essences of the present disclosure within the spirit and principles of the present disclosure without departing from the contents of the technical solutions of the present disclosure, should fall within the protection scope of the technical solutions of the present disclosure.

What is claimed is:

1. An integrated additive, subtractive and repair friction stir device, wherein the device comprises a friction stir additive manufacturing (FSAM) module, a subtractive module, a wire feeding module, and a surface profile detection module, wherein
the FSAM module is fixedly connected to a first rotor of a spindle; the FSAM module comprises a stirring tool and a compression ring, wherein a lower end of the stirring tool is inserted into the compression ring, the stirring tool comprises a first clamping end, a cutting portion, and stirring pins, and the first clamping end, the cutting portion, and the stirring pins are connected sequentially from top to bottom into an integral structure; an upper end of the compression ring is provided with a second clamping end, the second clamping end is fixedly connected to a stator of the spindle via fastening screws, and a lower end of the compression ring is provided with a shoulder; and a first wire feeding hole is formed in a side wall of the compression ring;
the subtractive module is located in the FSAM module and fixedly connected to a second rotor of the spindle; and the subtractive module comprises a milling cutter, wherein an upper end of the milling cutter is fixedly connected to the second rotor of the spindle, and a second wire feeding hole is formed in a side surface of the milling cutter;
the wire feeding module is configured to supply a wire material to the FSAM module and the subtractive module, respectively; and
the surface profile detection module is detachably connected to the FSAM module and configured to perform real-time detection of a surface quality of a deposited layer, comprising performing a defect analysis on an acquired image to obtain a defect location, and a defect depth, and a defect type of the deposited layer, and the milling cutter is controlled by the spindle to remove a surface defect of the deposited layer by milling.

2. The integrated additive, subtractive and repair friction stir device according to claim 1, wherein the wire feeding module comprises a wire feeder and the wire material, wherein the wire material is supplied to the FSAM module and the subtractive module through the wire feeder.

3. The integrated additive, subtractive and repair friction stir device according to claim 1, wherein the surface profile detection module comprises a data processing unit, a laser profile sensor, and a connecting plate, wherein the data processing unit and the laser profile sensor are mounted on a lower surface of the connecting plate from top to bottom, the laser profile sensor is provided with a laser emitter and a receiver, the laser emitter is configured to project a laser beam onto a surface of a detected object, and the receiver is configured to receive a reflected light signal, and transmit the signal to the data processing unit.

4. A processing method based on the integrated additive, subtractive and repair friction stir device according to claim 1, wherein the method is implemented through the following steps:
step 1, performing additive manufacturing through an FSAM module;
step 2, detecting a surface defect of an additive layer through a surface profile detection module, repairing the defect through a subtractive module, and restarting the additive process after repair is completed; and
step 3, after an additively manufactured component is manufactured, performing precision machining on the additively manufactured component through the subtractive module.

5. The processing method based on the integrated additive, subtractive and repair friction stir device according to claim 4, wherein the step 1 specifically comprises: when the additive process starts, a first rotor of a spindle starts operating and rotates at a high speed, while a second rotor remains stationary; a wire material is continuously and uninterruptedly passed sequentially through a first wire feeding hole and a second wire feeding hole; subsequently, the wire material contacts a high-speed rotating cutting portion and is sheared into small particles, and due to a high-speed relative motion between a high-speed rotating stirring tool and the non-rotating subtractive module, the sheared wire material flows along a processing path of a helical groove of the cutting portion; and when flowing to a bottom, the thermoplasticized material is deposited under the action of stirring pins and a compression ring to form a dense additive layer.

6. The processing method based on the integrated additive, subtractive and repair friction stir device according to claim 4, wherein the step 2 specifically comprises: when the spindle starts additive deposition along a preset path, the surface profile detection module located behind the spindle, i.e., above the deposited layer, starts operating; a laser emitter projects a laser beam onto a surface of a detected object, a receiver receives a reflected laser signal and transmits the signal to a data processing unit; a defect analysis is performed on an acquired image to obtain a defect location, a defect depth, and a defect type of the deposited layer; subsequently, a wire feeder stops wire feeding and controls retraction of the wire material, and the spindle of the device starts to lift and moves to a starting position of the defect; and at this moment, the first rotor of the spindle stops rotating, the second rotor of the spindle starts operating and rotates at a high speed, and independently controls the subtractive module to start moving axially downward, the surface defect of the deposited layer is removed by milling with a milling cutter, and after the surface defect is removed and the second rotor controls the subtractive module to move axially to an initial preset position, the additive process restarts.

7. The processing method based on the integrated additive, subtractive and repair friction stir device according to claim 4, wherein the step 3 specifically comprises: after the additively manufactured component is manufactured, the wire feeder stops wire feeding; the first rotor of the spindle stops rotating, the second rotor starts operating and rotates at high speed, and independently controls the subtractive module to start moving axially downward; and when a length of helical teeth extending at a lower end of the subtractive module below an end plane of the cutting portion meets the requirement, axial movement stops, and finally, the spindle controls the subtractive module to perform precision machining on the additively manufactured component according to a preset subtractive machining path.
